(19) United States
(12) Patent Application Publication
(10) Pub. No.: US 2010/0209754 A1
(43) Pub. Date: Aug. 19, 2010

(54) BATTERY LATCHING MECHANISM

(75) Inventor: LU ZUO, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/607,300

(22) Filed: Oct. 28, 2009

(30) Foreign Application Priority Data
Feb. 16, 2009 (CN) 200910300430.4

(51) Int. Cl. H01M 2/10

(52) U.S. Cl. 429/100

(57) ABSTRACT

A battery latching mechanism is provided. The battery latching mechanism comprises a body member including a battery receiving space and a latch portion adjacent to the battery receiving space, and a battery including a latch. The battery is received in the battery receiving space with the latch engaging with the latch portion.

### BACKGROUND

1. Technical Field

The present disclosure relates to battery latching mechanisms, and particularly, to a battery latching mechanism used in a portable electronic device.

2. Description of Related Art

Portable electronic devices are typically powered by batteries. A battery latching mechanism is provided to fasten the battery within the electronic device.

The battery latching mechanism typically includes a body member and a latching assembly fixed to the body member. The body member defines a receiving space to receive the battery. The latching assembly includes a button, a plurality of protrusions and a spring. The button is slidably mounted on the body member adjacent to the receiving space. The protrusions are configured for biasing the spring to secure the battery in the receiving space and can be released by the button.

However, such battery latching mechanisms can be complicated and inconvenient for users to remove the battery from the receiving space.

Therefore, there is room for improvement within the art.

### BRIEF DESCRIPTION OF THE DRAWINGS

Many aspects of the battery latching mechanism using same can be better understood with reference to the following drawings. These drawings are not necessarily drawn to scale, the emphasis instead being placed upon clearly illustrating the principles of the present battery latching mechanism. Moreover, in the drawings like reference numerals designate corresponding sections throughout the several views.

FIG. 1 is an exploded, isometric view of a battery latching mechanism, in accordance with an exemplary embodiment.

FIG. 2 is similar to FIG. 1, but viewed from another aspect.

FIG. 3 is an enlarged view of area III shown in FIG. 1.

FIG. 4 is an isometric, assembled view of the battery latching mechanism shown in FIG. 1.

FIG. 5 is a cross-sectional view of the battery latching mechanism shown in FIG. 4.

### DETAILED DESCRIPTION

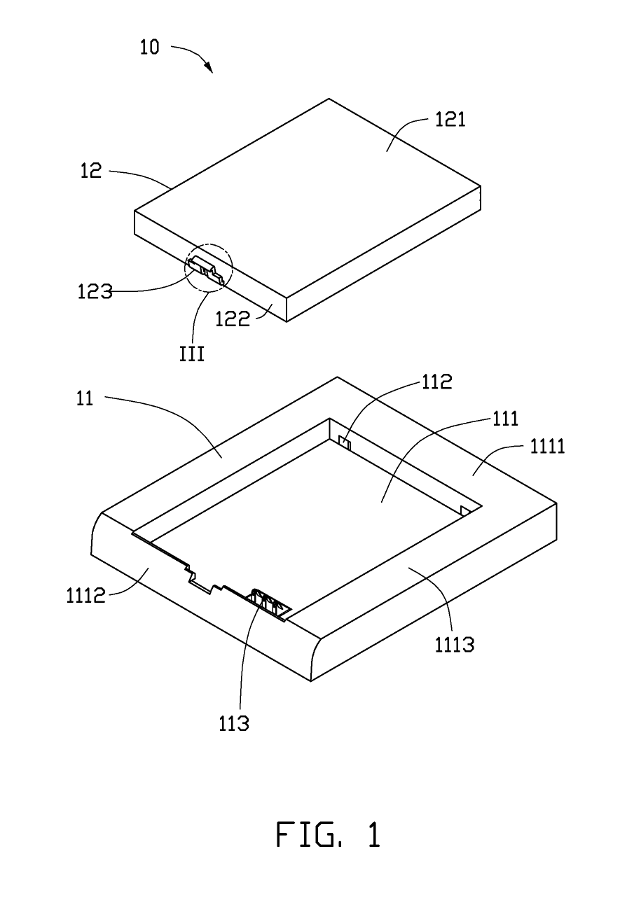

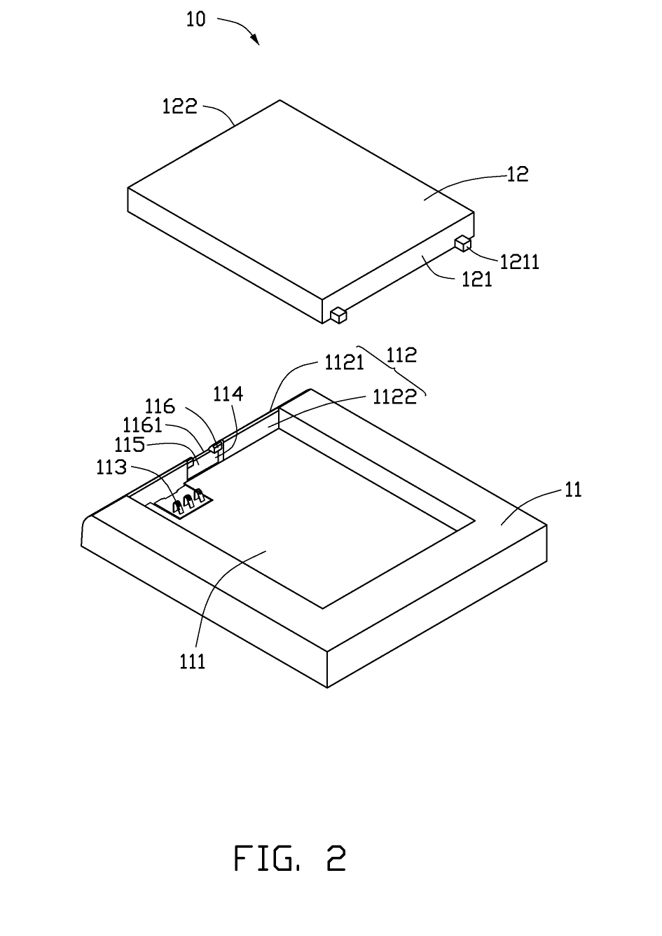

FIGS. 1 and 2 show an exemplary battery latching mechanism 10 for portable electronic devices, such as mobile phones, digital cameras and etc. The battery latching mechanism 10 includes a body member 11, and a battery 12. The battery 12 is to be latched to the body member 11.

The body member 11 defines a battery receiving space 111, used to receive the battery 12. The battery receiving space 111 is surrounded by a top portion 1111, a bottom portion 1112, and two side portions 1113. The body member 11 may be a portion of the body section of the portable electronic device. The top portion 1111 defines two limiting slots 112, facing the battery receiving space 111. An electrical connector 113 is formed on the body member 11 for electrically connecting with the battery 12. The connector 113 is in the battery receiving space 111, adjacent to the bottom portion 1112. The bottom portion 112 includes an exterior surface 1121 and an interior surface 1122 opposite to the exterior surface 1121. The exterior surface 1121 may be an arced surface. The interior surface 1122 is recessed to define a notch 114 at a center. The notch 114 is surrounded by a latch portion 115. Two latch blocks 116 spacingly protrude from the latch portion 115, facing inwardly. The two latch blocks 116 are located at an upper end of the latch portion 115, away from the battery receiving space 111. The two latch blocks 116 define a cutout 1161 therebetween.

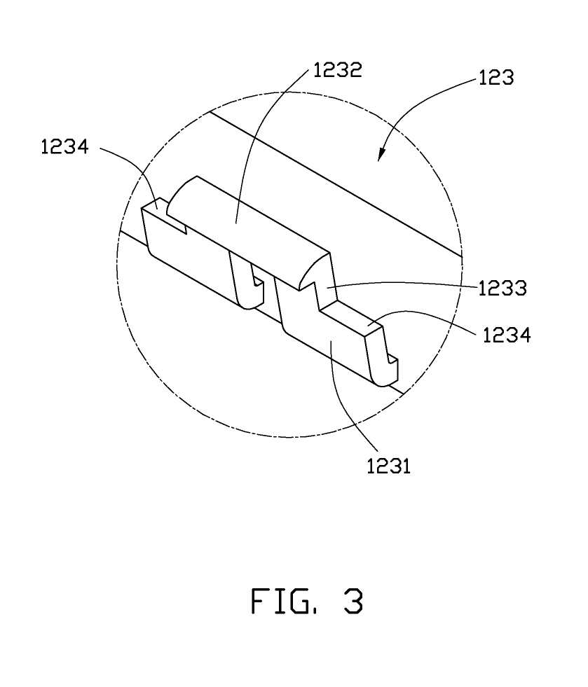

The battery 12 includes a first end 121 and a second end 122. Two limiting blocks 1211 protrude from the first end 121. The limiting blocks 1211 are for engaging with the limiting slots 112 of the body member 11. A latch 123 protrudes from the second end 122, corresponding to the latch portion 115. Referring to FIG. 3, the latch 123 includes a main portion 1231. One end of the main portion 1231 is secured to the second end 122, the other end is an operating portion 1232. Therefore, the latch 123 can be biased against the securing end thereof. The operating portion 1232 facilitates operating of the latch 123. Each side of the main portion 1231 defines a gap 1233, thus forming a latching wall 1234, corresponding to the latch blocks 116. Each latching wall 134 latches with a corresponding latch block 116.

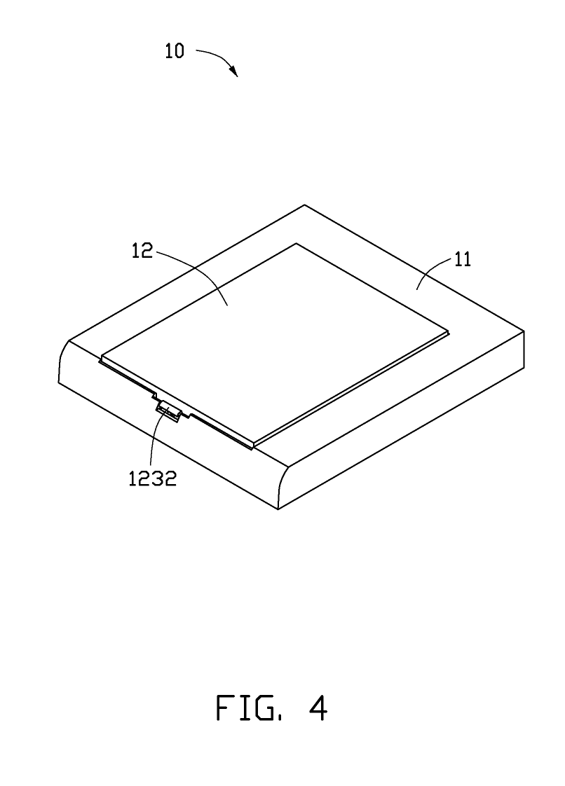

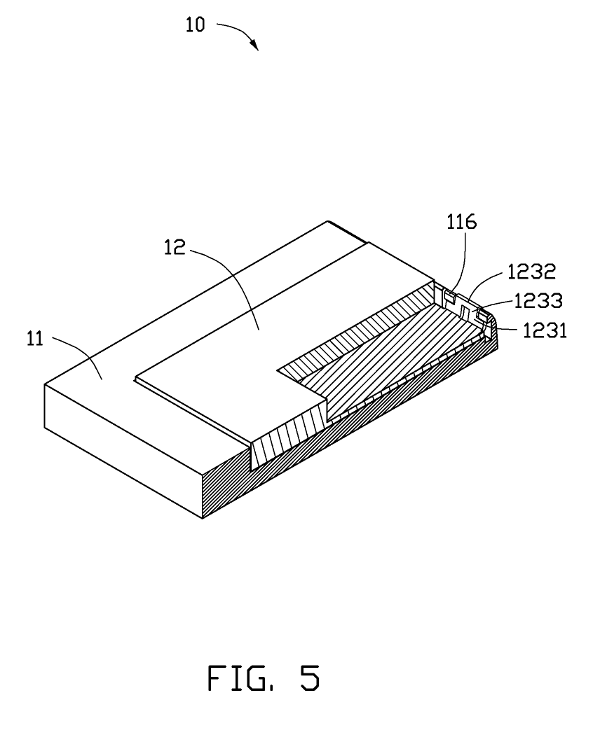

FIGS. 4 and 5 show a holding state of the battery latching mechanism 10. To hold the battery 12, the first end 121 of the battery 12 is placed in the receiving space 111, with the two limiting blocks 1211 inserted into the limiting slots 112. The second end 122 of the battery 12 is pivoted about the first end 121 to the battery receiving space 111 until the latch 123 is received into the notch 114. The second end 122 of the battery 12 is further pivoted about the first end 121 to make the latch 123 biased and each latching wall 134 latches with a corresponding latch block 116.

To release the battery 12 from the battery receiving space 113, an external force is exerted on the operating portion 1232 until the latch 123 is released from the latch blocks 116. At this stage, the second end 122 of the battery 12 is pivoted about the first end 121 of the battery 12 until the second end 122 of the battery 12 is exposed out of the battery receiving space 111.

In the holding position, the battery latching mechanism 10 fastens the battery 12 by using the latch 123. Thus, the battery latching mechanism 10 is simple in structure and convenient to operate.

It is to be understood, however, that even through numerous characteristics and advantages of the present disclosure have been set forth in the foregoing description, together with details of the structure and function of the disclosure, the disclosure is illustrative only, and changes may be made in detail, especially in matters of shape, size, and arrangement of sections within the principles of the disclosure to the full extent indicated by the broad general meaning of the terms, in which the appended claims are expressed.

What is claimed is:

1. A battery latching mechanism, comprising:
a body member including a battery receiving space and a latch portion adjacent to the battery receiving space; and
a battery including a latch, the battery being received in the battery receiving space, the latch includes a main portion, one end of the main portion being secured to the battery, the other end of the main portion being an operating portion configured for facilitating releasable engagement between the latch and the latch portion of the body member.

2. The battery latching mechanism as claimed in claim 1, wherein two latch blocks spacingly protrude from the latch portion, each side of the main portion defines a gap, thus forming a latching wall, each latching wall latches with a corresponding latch block.

3. The battery latching mechanism as claimed in claim 1, wherein the battery receiving space is surrounded by a top portion, a bottom portion, and two side portions, the latch portion is defined in the bottom portion.

4. The battery latching mechanism as claimed in claim 3, wherein the top portion defines two limiting slots, facing the battery receiving space, the battery further includes two limiting blocks, each limiting block engages in the limiting slot.

5. The battery latching mechanism as claimed in claim 3, wherein the bottom portion includes an exterior surface and an interior surface opposite to the exterior surface, the interior surface is recessed to define a notch, the latch is biased in the notch.

6. The battery latching mechanism as claimed in claim 5, wherein the notch is surrounded by the latch portion.

7. A battery latching mechanism, comprising:
a body member including a latch portion; and
a battery including a latch, the latch includes a main portion, one end of the main portion being secured to the battery, the other end of the main portion being an operating portion configured for facilitating releasable engagement between the latch and the latch portion of the body member.

8. The battery latching mechanism as claimed in claim 7, wherein two latch blocks spacingly protrude from the latch portion, each side of the main portion defines a gap, thus forming a latching wall, each latching wall latches with a corresponding latch block.

9. The battery latching mechanism as claimed in claim 7, wherein the top portion defines two limiting slots, the battery further including two limiting blocks, each limiting block latching with the limiting slot.

10. The battery latching mechanism as claimed in claim 7, wherein the body member defines a notch, the latch is biased in the notch.

11. The battery latching mechanism as claimed in claim 10, wherein the notch is surrounded by the latch portion.
